(19) United States
(12) Patent Application Publication
(10) Pub. No.: US 2011/0026686 A1
(43) Pub. Date: Feb. 3, 2011

(54) USE OF UNIQUE REFERENCES TO FACILITATE CORRELATION OF DATA RETENTION OR LAWFUL INTERCEPTION RECORDS

(76) Inventors: Amedeo Imbimbo, Caivano (IT); Giuseppe Carnevale, Napoli (IT)

Correspondence Address: ERICSSON INC., 6300 LEGACY DRIVE, M/S EVR 1-C-11, PLANO, TX, 75024, US

(21) Appl. No.: 12/936,336

(22) PCT Filed: Apr. 7, 2008
(86) PCT No.: PCT/EP2008/054129

§ 371 Date: Oct. 4, 2010

(51) Int. Cl. H04M 3/22

(52) U.S. Cl. 379/35

(57) ABSTRACT

The invention relates to a method of providing call- or service-related information to a Lawful Interception (LI) system or to a Data Retention (DR) system in a telecommunications network. In the method, a node is provided, which is in communication with an interception requesting element of the LI/DR system. At the node, a record relating to a communication involving a target user is generated and finally sent to the interception requesting element. Before sending the record, at the node it is checked whether a unique reference univocally identifying the communication involving the target user is already available to the node and, if not, such unique reference is generated by the node. Finally, the unique reference is included in the record, which can then be sent to the interception requesting element.

### TECHNICAL FIELD

The present invention relates to methods and arrangements in a telecommunications system comprising Data Retention (DR) sources and/or Intercepting Control Elements (ICE) for providing data to law enforcement agencies. More in detail, the telecommunications systems in which the present invention can be implemented comprise nodes acting as DR sources or ICEs for the retention or interception of services data, respectively.

### BACKGROUND

In many countries operators and Internet service providers are today obliged by legal requirements to provide stored traffic data generated from public telecommunications and Internet services for the purpose of detection, investigation and prosecution of crime and criminal offences, including terrorism.

FIG. 1 depicts the known arrangement for retaining data in a Communication Service Provider 1 (CSP). Specifically, the CSP 1, which may incorporate existing communication systems 2, is provided with a Data Retention System (DRS) 3 for exchanging retained data with a Requesting Authority 4, which may be a Law Enforcement Agency (LEA).

The data exchanged between the CSP 1 and the Requesting Authority 4 comprises requests from the Requesting Authority 4, corresponding responses from the DRS and other DR information, such as results of the requests and acknowledgements of receipt. The interfaces through which the CSP and DRS exchange the above data with the Requesting Authority are denoted as Handover Interfaces.

The generic Handover Interface adopts a two-port structure in which administrative request/response information and Retained Data Information are logically separated. In particular, a first Handover Interface port HI-A 5 is configured to transport various kinds of administrative, request and response information from/to the Requesting Authority 4 and an organization at the CSP 1 that is responsible for Retained Data matters, identified by an Administration Function 7.

A second Handover Interface HI-B 6 is configured to transport the retained data information stored in a repository 9 from the CSP 1 to the Requesting Authority 4. The individual retained data parameters have to be sent to the Requesting Authority 4 at least once (if available). To this aim, a Mediation/Delivery function 8 is provided, for retrieving the retained data from the memory means 9 and forward such data to the Requesting Authority 4 in a suitable format through the HI-B 6.

A second system for accessing communications related data is the well-known Lawful Interception (LI) system, which is depicted in FIG. 2. The standard architecture 10 comprises an Intercepting Control Element (ICE) 11 providing the user equipment of the target user with an access to the telecommunications network. ICEs may be, for instance, a Mobile services Switching Center (MSC) Server, a Gateway MSC Server, a Serving GPRS Support Node (SGSN), or a Gateway GSN (GGSN).

The architecture 10 further comprises one or more Law Enforcement Monitoring Facilities (LEMFs) 12 through which respective LEAs receive interception information.

An Administration Function (ADMF) entity 13 is further configured to send the target identity and LI authorization data from the LEAs to the ICE.

Every physical ICE 11 is linked to the ADMF by means of its own X1_{—}1 interface. Consequently, every single ICE performs interception, i.e. activation, deactivation, interrogation as well as invocation, independently from other ICEs.

In order to deliver the intercepted information to the LEAs, two Delivery Functions (DF) entities are provided, each exchanging respective portions of information with the ADMF 13 (through X1_{—}2 and X1_{—}3 interfaces) and the LEMF 12.

In particular, a DF2 entity 15 is configured to receive Intercept Related Information (IRI) from the ICE, through an X2 interface, and to convert and distribute the IRI to the relevant LEAs via a second Handover Interface 16 (HI2) by means of a Mediation Function (MF) 17.

The IRI is a collection of information or data associated with telecommunication services involving the target identity, such as call associated information or data (e.g. unsuccessful call attempts), service associated information or data (e.g. service profile management by subscriber) and location information.

A DF3 entity 18, instead, is configured to receive Content of Communications (CC) information from the ICE 11 through an X3 interface, and to convert and distribute such information to the relevant LEA through an MF 19 and a third Handover Interface (HI3).

For the lawful interception, the correlation of IRIs is based on the Communications Identity Number (CIN), which is currently used in the header of IRI messages to identify uniquely the communications session within the relevant network element. In order to clarify the proposal, the ETSI TS 102 232 will be used as example of Handover Interfaces used for the delivery to the agencies. The same mechanism is used in other LI HI standards. In this protocol, the correlation of the data belonging to the same communications session is based on the communication identifier, consisting of the Network Identifier (NID), the CIN and Delivery Country Code (DCC).

A problem of the current systems is that even by using the CIN normally contained in the IRIs, it is not possible to correlate DR and LI records coming from different nodes.

The LEAs could correlate these records only by using empiric analysis of the received data, e.g. by looking at the time stamps. However, such empiric analysis is lengthy and not fully reliable because it often happens that the time interval between the emissions of records from the various node elements is not short enough to allow the LEA to correlate the data based on such time stamps.

This problem is particularly frequent when DR or LI records relate to SMS messages, because such messages may take several minutes and even hours to arrive at their destination. If many SMS messages are sent by the same target user during such minutes/hours, the LEA would have no reliable information that the records retrieved from the LI or DR system do regard a certain SMS message.

### SUMMARY

The aim of the present invention is to provide a method and a node that overcome the above drawbacks.

This aim and other objects which will become better apparent hereinafter are achieved by a method of providing call- or service-related information to a Lawful Interception LI system in a telecommunications network. In the method a node is provided, which is in communication with an interception requesting element of the LI system. At the node, a record relating to a communication involving a target user is generated and finally sent to the interception requesting element. Before sending the record, at the node it is checked whether a unique reference univocally identifying the communication involving the target user is already available to the node and, if not, such unique reference is generated by the node. Finally, the unique reference is included in the record, which can then be sent to the interception requesting element.

The communication involving the target user may be a terminating call or an originating call. The record may be sent by the node to the interception requesting element after the call is terminated.

In other embodiments of the invention, the communication involving the target user may be an originating or a terminating Short Message (SM). In this case, the unique reference is a Short Message reference included in a signaling protocol of the telecommunication network, and may be obtained by hashing of the contents of the SM.

The node may check whether the unique reference has been received from a second node of the telecommunications network.

Preferably, the unique reference is a call reference included in a signaling protocol of the telecommunications network. Such call reference may be selected among a network call reference of an ITU-T ISUP signaling protocol, a generic digit parameter of an ANSI ISUP signaling protocol; a global search identity parameter of a TTC ISUP signaling protocol; a global call reference parameter of a BICC signaling protocol.

Before generating the record, the node may receive via trunk signaling a message from a second node of the same telecommunications network or of a different telecommunications network, which message may comprise the unique reference as an information element. Such message may be received at call setup.

If the communication involving the target user comprises a plurality of related calls, the checking performed by the node may include checking if the unique reference is already available from at least one of such related calls. Related calls may be, for instance, the calls in a multi-party service.

The interception requesting element may comprise at least one Law Enforcement Agency and a Delivery Function. In this case, the record is sent to the Delivery Function as Intercept Related Information.

In alternative to the LI system, a Data Retention system may be used. In this case, instead of the interception requesting element, a DR system will receive the records containing the unique reference from the telecommunications network nodes and will store them in a repository.

The present invention also concerns computer programs comprising portions of software codes in order to implement the method as described above when operated at a processor of a telecommunications node. Such a computer program can be stored on a computer readable medium. The computer-readable medium can be a permanent or rewritable memory within the controller or the switch or can be located externally. The respective computer program can be also transferred to the controller or the switch for example via a cable or a wireless link as a sequence of signals.

According to the invention, a telecommunications node is also provided. The node comprises means for generating a record relating to a communication involving a target user and means for sending the record to an interception requesting element of a Lawful Interception LI system or to a Data Retention DR system. The means for generating the record comprise means for checking whether a unique reference univocally identifying the communication involving the target user is already available to the node, and means for generating the unique reference if the unique reference is not already available to the node. The telecommunications node further comprises means for including the unique reference in the record.

The means for checking may be adapted to check whether the unique reference has been received from a second node of the telecommunications network.

The unique reference may be a call reference included in a signaling protocol of the telecommunications network to which the telecommunications node belongs. Preferably, the call reference is selected from the group comprising a network call reference of an ITU-T ISUP signaling protocol; a generic digit parameter of an ANSI ISUP signaling protocol; a global search identity parameter of a TTC ISUP signaling protocol; a global call reference parameter of a BICC signaling protocol.

The telecommunications node according to the invention may further include means for receiving, via trunk signaling, a message from the second node which comprises the unique reference as an information element. The message is preferably received at call setup.

If the communication involving the target user comprises a plurality of related calls, e.g. in a multi-party service, the means for checking are adapted to check whether the unique reference is available from at least one of the related calls.

Moreover, if the communication involving the target user is a Short Message communication, the telecommunications node according to the invention may be one or more of a Mobile Switching Center (MSC), a Short Message Service Interworking MSC (SMS-IWMSC), a Short Message Service Gateway MSC (SMS-GMSC).

According to the invention, a telecommunications network comprising a Lawful Interception LI system or a Data Retention system and comprising a plurality of the above telecommunication nodes is also provided.

Preferably, if the communication involving the target user is a Short Message communication, the unique reference in this case may be generated by the originating MSC and passed through the SMS-IWMSC, the SMS-GMSC, the and the terminating MSC.

An important advantage of the invention is that at the LI system or at the DR system handover interfaces data received from different nodes for the same communication can be correlated by using the unique reference present in the records. Specifically, the correlation of DR records coming from different node elements, or of LI records coming from different node elements, or of DR and LI records is allowed.

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 is a known arrangement of a communication service provider with Data Retention (DR) capabilities;

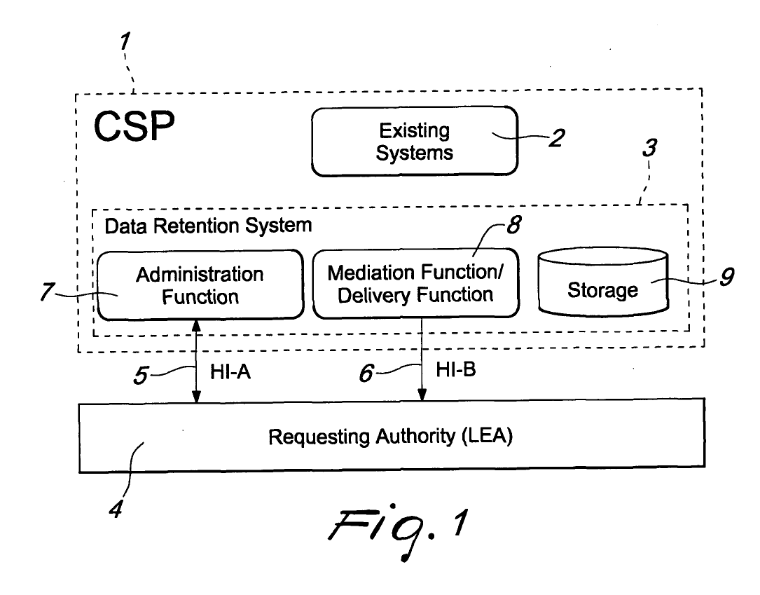

FIG. 2 is a known arrangement of a Lawful Interception system;

FIG. 3 is a block diagram showing possible records produced by the nodes involved in a terminating call interception;

FIG. 4 is a flow diagram of the terminating call Lawful Interception of FIG. 3;

FIG. 5 is a block diagram showing possible records produced by the nodes involved in Data Retention of a terminating call;

FIG. 6 is a flow diagram of the terminating call Data Retention of FIG. 5;

FIG. 7 is a block diagram showing possible records produced by the nodes involved in a terminating Short Message Service system with Data Retention;

FIG. 8 is a flow diagram of a Short Message Data Retention system of FIG. 7.

### DETAILED DESCRIPTION

In a telecommunications network comprising a Lawful Interception (LI) system or a Data Retention (DR) system, nodes respectively acting as Intercept Control Element (ICE) or to a Data Retention Source can generate records.

Such records may include an originating call record, issued by a node where the call is originating, a roaming call forwarding record issued by a Gateway Mobile Switching Center (GMSC) node in the home Public Land Mobile Network (PLMN) of the terminating user, or a terminating call record issued by a node where the call is terminating, either in the home or in the visited PLMN.

Other records are in addition possible in more complex call scenarios, where there are nodes involved in call forwarding, Intelligent Network (IN) services invocation or call transit.

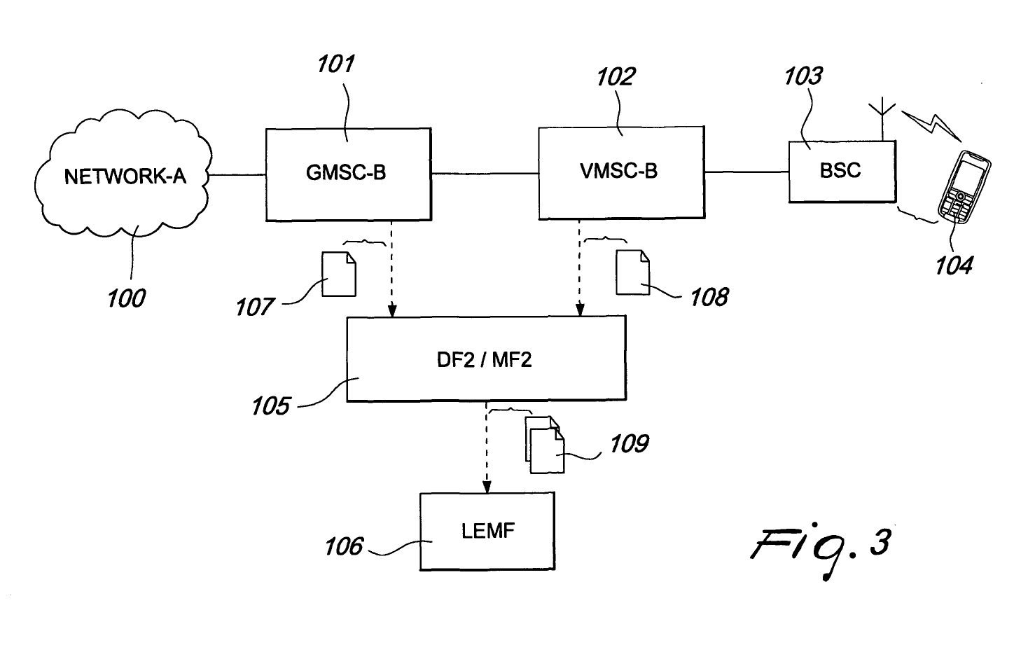

In FIG. 3, a network according to a first embodiment of the invention is shown, which comprises nodes involved in a terminating call under lawful interception. Specifically, the nodes at the terminating side (the B-side) include a Gateway Mobile services Switching Center (GMSC) 101 and a Visited Mobile services Switching Center (VMSC) 102. The GMSC 101 is configured to receive a call from an originating switch of the originating network 100 (network A) and forward such call to the VMSC 102, which will accordingly deliver the call to the destination Mobile Station 104 via a Base Station Controller 103 or an equivalent radio transmission station.

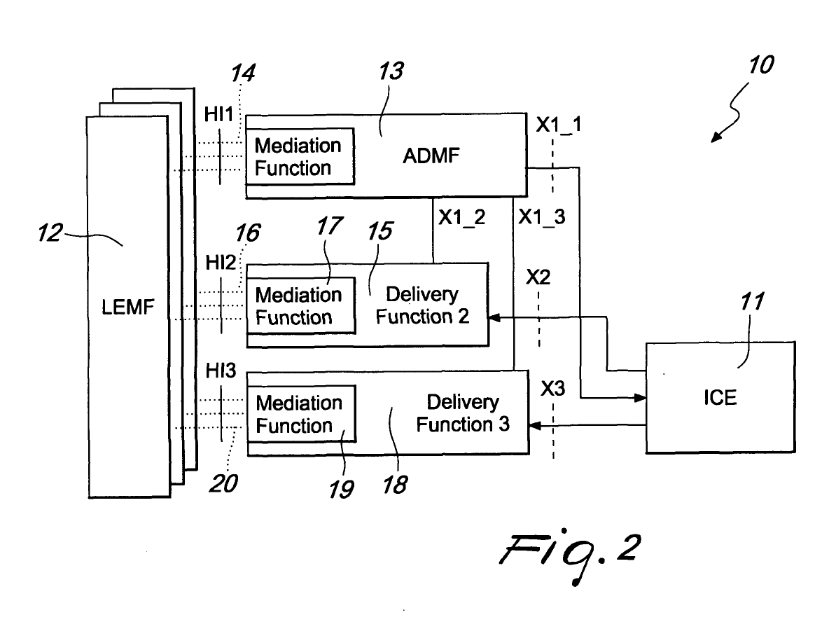

The switching centers 101-102 are in communication with an LI system such as the system of FIG. 2 and are configured to generate respective records 107 and 108 after the call is released. Such records are herein referred to as Terminating call records. The LI system comprises a DF2/MF2 105 which is configured to receive such records as Intercept Related Information (IRI) from the Switching Centers 101-102 and to convert and distribute the converted records 109 to the LEMF 106.

According to a general aspect of the invention, the nodes that generate records for the LI system or for the DR system are configured to provide the respectively generated records with a same reference univocally identifying the specific communication involving the target user. As a consequence, all of the records received by the LI system or by the DR system from the various nodes of the network and relating to a certain communication of the target user contain the same unique reference, which allows to correlate and trace the records processed in different nodes in one or more networks. Such reference may be a unique identifier for a specific CSP or it may be common to all or some CSPs depending on specific agreements between operators.

Moreover, the newly introduced unique reference may be equal to or mapped from either references already used in the call charging system, such as the Global Call Reference or the Network Call Reference in case of circuit-switched calls. In particular, the unique reference may correspond to parameters currently used only for call charging purposes such as the network call reference used in the ITU-T ISUP signaling protocol, or the generic digit parameter of the ANSI ISUP signaling protocol, or the global search identity parameter of the TTC ISUP signaling protocol, or the global call reference parameter of the BICC signaling protocol.

The reference is preferably provided as a new information element (IE) in signaling messages between the nodes which issue the records directed to the LI or DR system, so that each node can decide on whether the unique reference must be generated by the node itself or whether the unique reference is already available because it has been received from another node.

In the first embodiment of the invention, either the GMSC 101 or the VMSC 102 or both are configured to check whether a unique reference univocally identifying a communication involving the target user B is already available to them, for instance because the reference has been received via a signaling message or it is already locally stored. If the unique reference is not available, the GMSC 101 or the VMSC 102 can generate it locally.

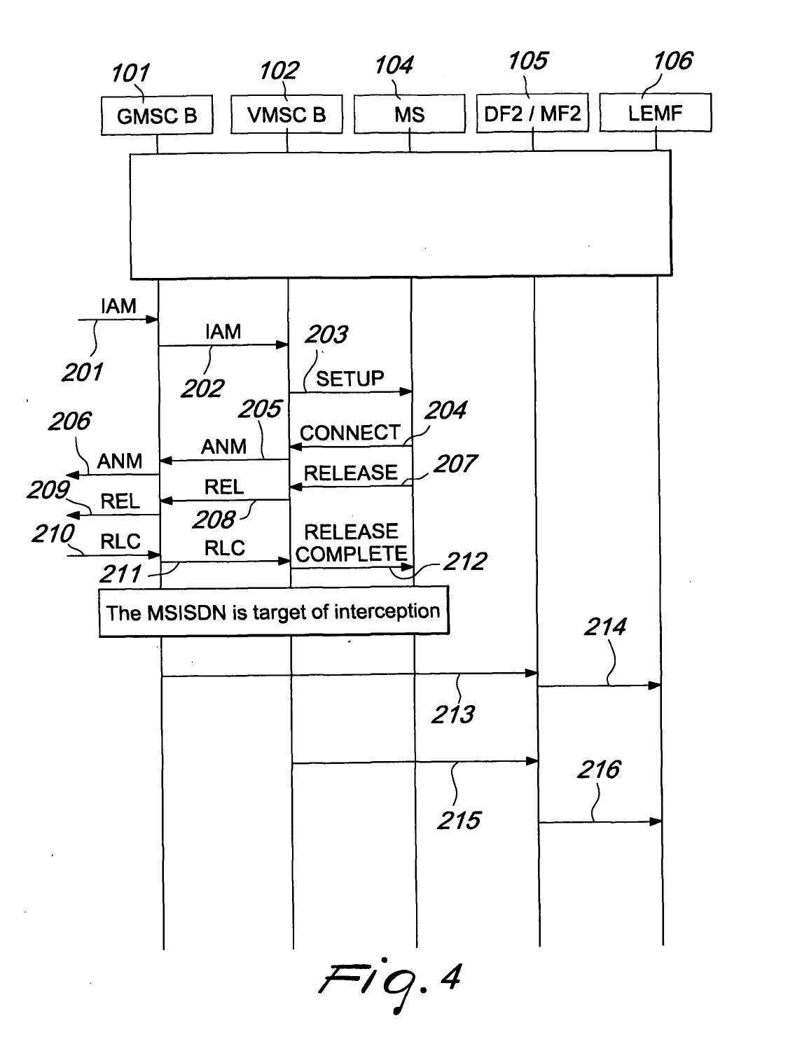

More in detail, with reference to FIG. 4, and considering an ISUP signaling, in step 201 a IAM (Initial Answer Message) is received by the GMSC 101 of the intercepted user B for a call originated from a user A in another operator network 100.

If there is no specific agreement between the operators of the two networks of the users A and B, the IAM of step 201 does not comprise a global call reference. Accordingly, the GMSC 101, i.e. the first node involved in the call directed to the intercepted user B, generates a network call reference for such call and forwards the IAM including the network call reference as an information element to the VMSC 102 of user B (step 202).

In other embodiments of the invention, not shown in the figures, the IAM received by the GMSC of user B may already contain a unique reference, such as the Global Call Reference. In this case, the GMSC according to the invention realizes that a unique reference for the call is already available and will not generate a new reference for that call.

In step 203, the VMSC 102 via the associated base station 103 sets up the call by ringing the mobile station (MS) 104 of user B and, in step 204, the VMSC 102 receives a confirmation that the call has been answered by the user. Then, in step 205, the VMSC 102 sends an Answer Message (ANM) to the GMSC 101, which is finally forwarded to the originating switch of network A 100 (step 206).

At the release of the call (step 207), the VMSC 102 sends a Release Message (REL) to the GMSC 101 (step 208), which is then forwarded to the originating switch of network A (step 209). The GMSC 101 accordingly receives a Release Complete Message (RLC) from the originating switch of network A (step 210) and notifies the VMSC 102 with such message (step 211). The MS 104 may be also notified of the release completion (step 212).

After the release of the call, in step 213, a first terminating call record 107 is generated by the GMSC 101 so that it contains the Network Call Reference and IRI of the call. The first terminating call record 107 is sent by the GMSC 101 to the DF2/MF2 105, which converts the record and sends the converted record to the LEMF 106 (step 214).

Similarly, a second terminating call record 108 may be also generated by the VMSC 102 so that it includes the same Network Call Reference and the IRI available to the VMSC 102 and it is sent to the DF2/MF2 105 (step 215). The DF2/MF2 finally converts the second terminating call record and sends the converted record to the LEMF 106 (step 216).

Based on the network call reference provided in the records, the LEAs will be able to correlate the terminating call records generated by the nodes of the network, without any empirical analysis or deep inspection of the records.

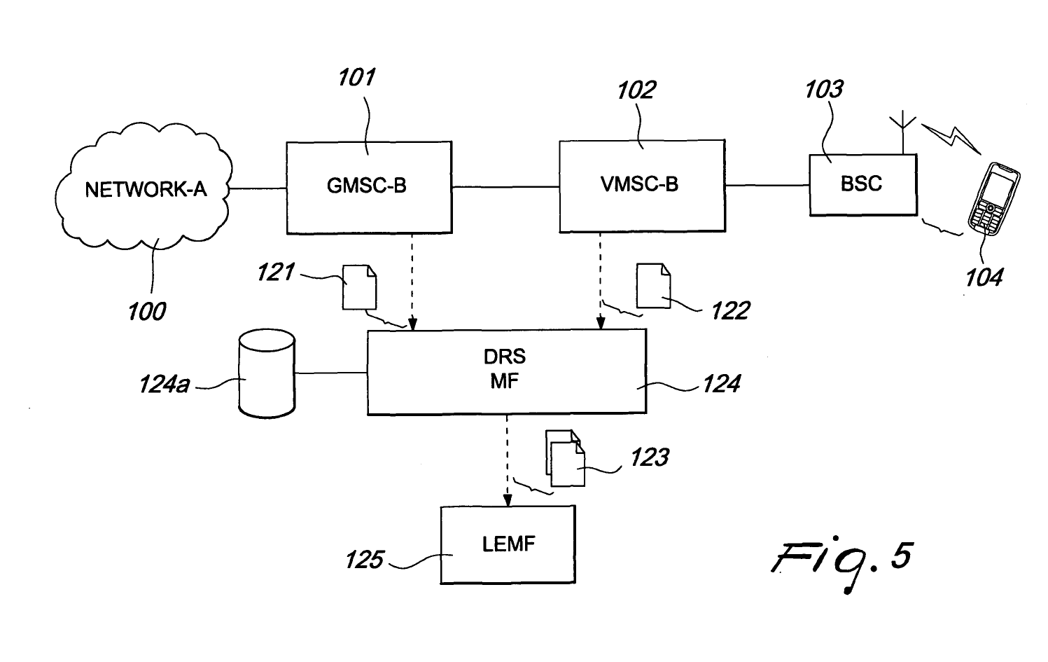

In a second embodiment of the invention, which is shown in FIG. 5, the terminating-side network may interact with a Data Retention system instead of with an LI system, without altering the effects of the invention. Specifically, using the same references numbers already used in FIG. 3 for the same nodes, the GMSC 101 and the VMSC 102 of the target user B are connected to a DR mediation function 124, which is in communication with a DRS storage 124a.

The GMSC 101 is configured to check whether a unique reference univocally identifying a communication involving the target user B is already available to the GMSC 101, for instance because the reference has been received via a signaling message or it is already locally stored. If the unique reference is not available, the GMSC 101 can generate it locally. The same checking and generating operation can be performed by the VMSC 102 as well.

Both the GMSC 101 and VMSC 102 are configured to generate, at the release of a call directed to the mobile station 104 of target user B, respective terminating call records 121 and 122 containing respective call data and a same call reference.

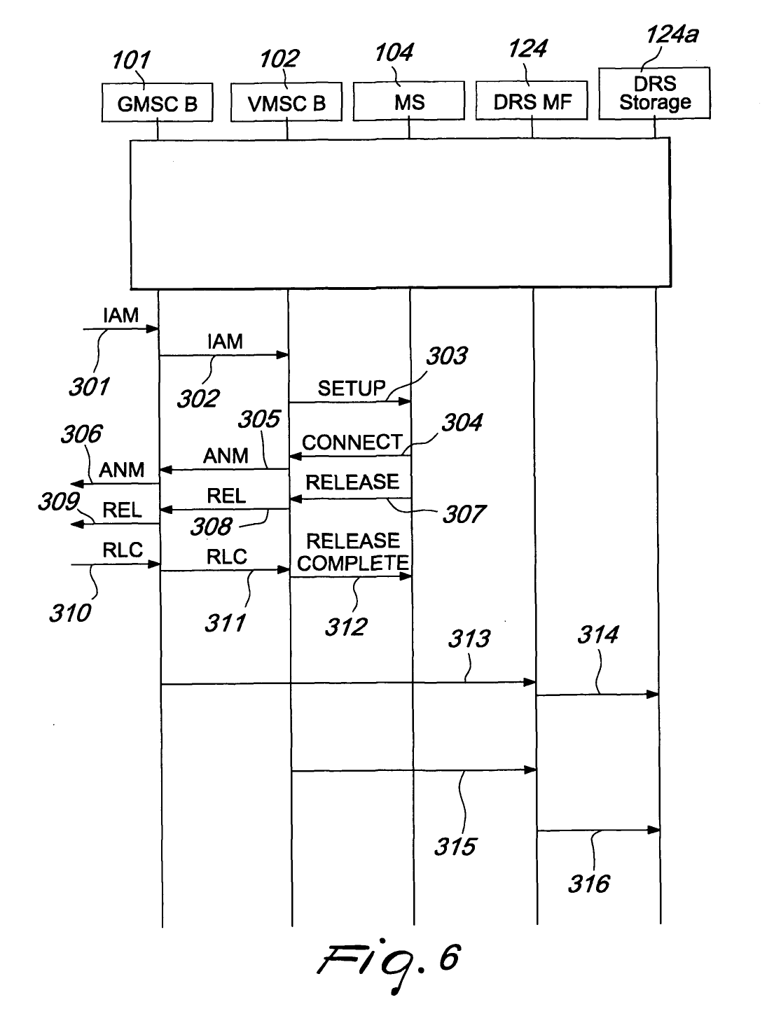

The operation of the second embodiment is as follows. With reference to FIG. 6, in step 301 a IAM (Initial Answer Message) is received by the GMSC 101 of the intercepted user B for a call originated from a user A in another operator network 100.

If there is no specific agreement between the operators of the two networks of the users A and B, the IAM of step 301 does not comprise a global call reference. Accordingly, the GMSC 101 generates a network call reference for such call and forwards the IAM including the network call reference as an information element to the VMSC 102 of user B (step 302).

In step 303, the VMSC 102 sets up the call, via the associated base station 103, by ringing the mobile station (MS) 104 of the target user B and, in step 304, the VMSC 102 receives a confirmation that the call has been answered by the user. Then, in step 305, the VMSC 102 sends an Answer Message (ANM) to the GMSC 101, which is finally forwarded to the originating switch of network A 100 (step 306).

At the release of the call (step 307), the VMSC 102 sends a Release message (REL) to the GMSC 101 (step 308), which is then forwarded to the originating switch of network A (step 309). The GMSC 101 accordingly receives a Release Complete message (RLC) from the originating switch of network A (step 310) and notifies the VMSC 102 with such message (step 311). The MS 104 may be also notified of the release completion (step 312).

Then, in step 313, a terminating call record 121 is generated by the GMSC 101 so that it contains the Network Call Reference and data related to the call and is sent by the GMSC 101 to the DRS Mediation Function 124, which converts the record and stores the converted record in the DRS repository 124a (step 314), for future retrieval by a LEA.

A terminating call record 122 may be also generated by the VMSC 102 which includes the same Network Call Reference and the call data available to the VMSC and which is sent to the DRS MF 124 (step 315). The DRS MF 124 converts such terminating call record too, and stores the converted record in the DRS repository 124a (step 316).

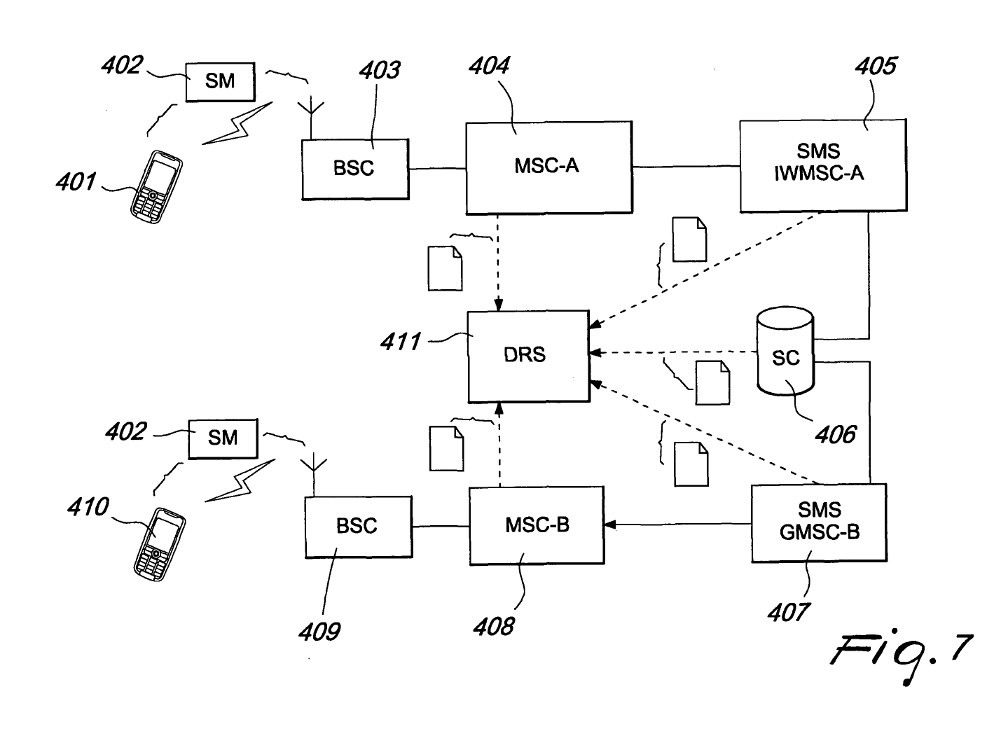

The invention can be implemented not only in nodes involved in a call, but also in nodes operated for providing a certain service to the target user. For instance, with reference to the embodiment shown in FIG. 7, the nodes modified according to the invention may be the nodes involved in a Short Message Service (SMS).

Specifically, the SMS system according to FIG. 7 comprises a mobile station (MS) 401 of a target user for generating an SM 402 to be delivered to the mobile station 410 of a destination user. Mobile stations 401 and 410 are served by respective MSCs 404 and 408, with which the mobile stations can communicate via Base Station Controllers 403 and 409. Obviously, the mobile stations 401 and 410 may be served by a same MSC, if they are in a same geographical area.

The MSC 404 is connected to an SMS Interworking MSC 405, which interfaces the MSC 404 to a Short Message Service Center (SC) 406. The SC 406 is also connected to a SMS-GMSC 407, which belongs to a different operator network (B) and which acts as a gateway for the terminating MSC 408.

In the particular embodiment shown in FIG. 7, all of the nodes 404, 405, 406, 407 and 408 are in communication with a DR system 411 and are configured to generate respective records for the DR system 411 after an SM from the mobile station of the target user has been delivered to the SC and/or to the destination mobile station 410.

Moreover, in accordance with the invention, one or more of the nodes 404, 405, 406, 407 and 408 are configured to generate a unique SM reference, if not already available, and to insert the generated reference into the respective records to be sent to the DR system 411.

The operation of the third embodiment of the invention is as follows. In step 501, the mobile station 401 generates and sends an SM 402 to the MSC 404, via the BSC 403. Then, the MSC 404 determines if a unique reference is already available for the received SM. Since the message is received directly from a MS, the MSC 404 will find no existing unique reference in the message and will accordingly generate a SM reference number (step 502), which will be also locally stored at the MSCNLR for the record to be sent to the DRS 411. Such SM reference will be passed through all the nodes in the direction of the terminating mobile station 410 and may even cross different operator networks.

The SM reference may be generated by the MSC 404 or by any other node according to any technique. For instance, a unique reference may be generated through hashing of the SM content. In this case, there may be no need to provide the requesting LEA with the content of the SM.

In step 503, the MSC 404 sends a “forwardShortMessage” message including the SM reference to the SMS-IWMSC 405, which transfers the message together with the SM reference to the SC 406 (step 504). Then, a delivery report is issued by the SC 406 and sent back to the SMS-IWMSC 405 (step 505), so that the report can be forwarded to the MSC 404 and, if necessary, to the mobile station 401 (steps 507 and 508).

After having sent the delivery report, the SC 406 issues a record of the originating SM comprising the SM reference and SM data and sends the same to the DRS-MF 411, which will store the SM record (step 506).

Similarly, the SMS-IWMSC 405 and the MSC 404 may send to the DRS 411 a respective originating SM record comprising the same SM reference and SM data, preferably after they have received the delivery report from the corresponding upstream node (steps 509 and 510).

In the meantime, the SC 406 transfers the SM and the SM reference to the SMS-GMSC 407 (step 511), which accordingly includes such information in a forwardShortMessage message and sends the message to the MSC 408 (step 512).

Subsequently, in step 513 the MSC 408 transfers the SM to the destination MS 410 and sends a delivery report to the SMS-GMSC 407 (step 514), which accordingly forwards the delivery report to the SC 406 (step 515).

After having sent the delivery report, the MSC 408 sends a terminating SM record comprising SM data and the SM reference to the DRS-MF 411 (step 516), which will store the terminating SM record. Similarly, the MSC 408 and the SMS-GMSC 407 may send to the DRS 411 a respective terminating SM record comprising the same SM reference and SM data respectively available to the MSC 408 and the SMS-GMSC 407, after they have received the delivery report from the corresponding upstream node (steps 517 and 518).

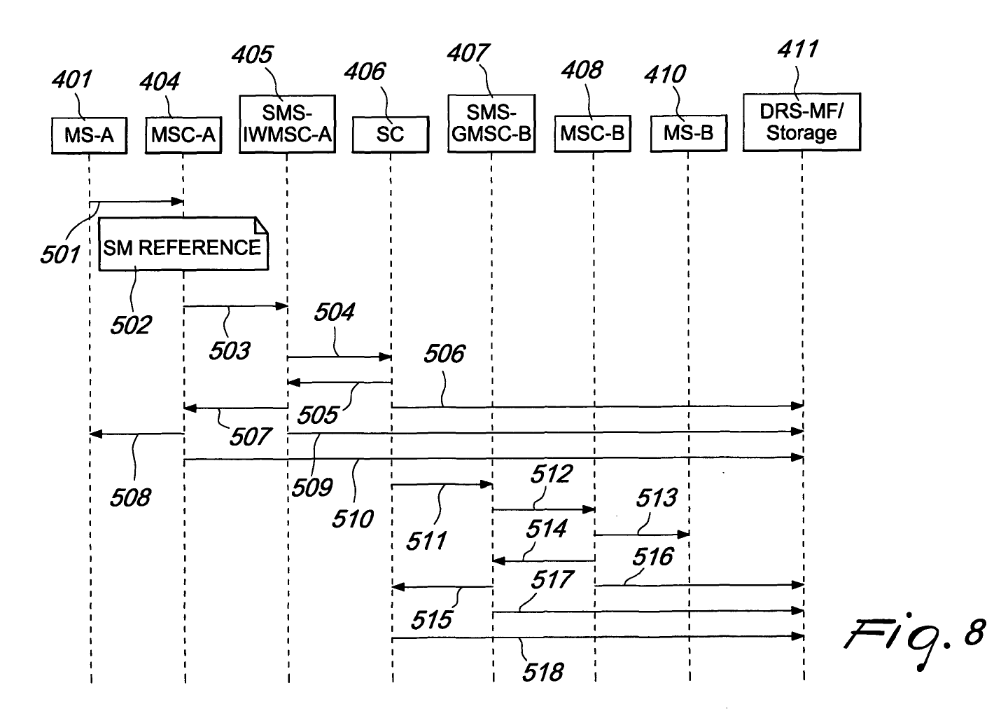

It is noted that, in another embodiment of the invention not shown in the figures, the network of FIG. 7 may comprise an LI system instead of a DR system. In this case, the operation described above with regard to FIG. 8 would apply without substantive changes. The main difference would consist in the generation and delivery of the SM records comprising the SM reference: such records, in steps 506, 509, 510, 516, 517 and 518, would be sent to the DF2/MF2 of the LI system. Some minor differences with respect to the DR case may also be present in the conveyed information.

In any case, because of the presence of a same SM reference in the SM records, the LEA accessing the DRS or the LI system will be able to correlate events related to the submission and the delivery of a SM without having to inspect the SM contents or empirical data such as the SM time stamp.

It has been shown that the invention fully achieves the intended aim and objects, since it provides a data retention or lawful interception requesting agency with information adapted to correlate events related to a certain communication involving a target user, be it a call or a service. Advantageously, if the communication is a call, call references already used in the call charging system may be used as references for univocally identifying the calls in the records to be sent to the LI or DR systems. Instead, in case of a service such as the SMS, a new SM reference is introduced, which avoids empirical analysis of the SM contents.

Clearly, several modifications will be apparent to and can be readily made by the skilled in the art without departing from the scope of the present invention. Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the skilled in the art.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A method of providing call- or service-related information to a Lawful Interception LI system in a telecommunications network, the method comprising:
providing a node which is in communication with an interception requesting element of the LI system;
generating, at the node, a record relating to a communication involving a target user;
sending said record to the interception requesting element;
characterized in that said generating the record comprises:
checking whether a unique reference univocally identifying said communication involving the target user is already available to the node and, if not, generating said unique reference;
including said unique reference in said record.

2. The method of claim 1, wherein said communication is a terminating call, an originating call or a Short Message SM.

3. The method of claim 1 or 2, wherein said checking includes checking if said unique reference has been received from a second node of the telecommunications network.

4. The method of one or more of the preceding claims, wherein said communication involving the target user is a call and said unique reference is a call reference included in a signaling protocol of the telecommunications network; or wherein said communication involving the target user is a Short Message SM and said unique reference is a SM reference included in a signaling protocol of the telecommunication network, said generating said unique reference optionally comprising generating said SM reference by hashing of the contents of said SM.

5. The method of claim 4, wherein said call reference is selected from the group comprising:
a network call reference of an ITU-T ISUP signaling protocol;
a generic digit parameter of an ANSI ISUP signaling protocol;
a global search identity parameter of a TTC ISUP signaling protocol;
a global call reference parameter of a BICC signaling protocol.

6. The method of one or more of claim 3, 4 or 5 further including the step of, before said generating the record, receiving via trunk signaling a message from said second node comprising said unique reference as an information element, wherein said message is preferably received at call setup.

7. The method of claim 1 or 2, wherein said communication involving the target user comprises a plurality of related calls, said checking includes checking if said unique reference is available from at least one of said related calls.

8. The method of one or more of the preceding claims, wherein said record is sent by the node to the interception requesting element after said call is terminated.

9. The method of one or more of the preceding claims, wherein the interception requesting element comprises at least one Law Enforcement Agency and a Delivery Function, said sending the record with the unique reference comprising sending the record to the Delivery Function as Intercept Related Information.

10. A computer program loadable into a processor of a telecommunications node, wherein the computer program comprises code adapted to perform the method of one or more of claims 1-9.

11. A telecommunications node comprising:
means for generating a record relating to a communication involving a target user;
means for sending said record to an interception requesting element of a Lawful Interception LI system or to a Data Retention DR system;
characterized in that said means for generating the record comprise:
means for checking whether a unique reference univocally identifying said communication involving the target user is already available to the node, and means for generating said unique reference if said unique reference is not already available to the node;
means for including said unique reference in said record.

12. The telecommunications node of claim 11, wherein said communication is a terminating call, an originating call or a Short Message SM.

13. The telecommunications node of claim 11 or 12, wherein said means for checking are adapted to check whether said unique reference has been received from a second node of the telecommunications network.

14. The telecommunications node of one or more of the preceding claims 11-13, wherein said unique reference is a call reference included in a signaling protocol of the telecommunications network to which said telecommunications node belongs.

15. The telecommunications node of claim 14, wherein said call reference is selected from the group comprising:
a network call reference of an ITU-T ISUP signaling protocol;
a generic digit parameter of an ANSI ISUP signaling protocol;
a global search identity parameter of a TTC ISUP signaling protocol;
a global call reference parameter of a BICC signaling protocol.

16. The telecommunications node of one or more of claim 13, 14 or 15 further including means for receiving via trunk signaling a message from said second node comprising said unique reference as an information element, said message being preferably received at call setup.

17. The telecommunications node of claim 11 or 12, wherein said communication involving the target user comprises a plurality of related calls, said means for checking being adapted to check whether said unique reference is available from at least one of said related calls.

18. The telecommunications node of one or more of the preceding claims 11-17, wherein said means for sending said record are adapted to send the record to the interception requesting element or to the DR system after said call is terminated.

19. The telecommunications node of claim 11, wherein said communication involving the target user is a Short Message communication, and said telecommunications node is any one of: a Mobile Switching Center (MSC), a Short Message Service Interworking MSC (SMS-IWMSC), a Short Message Service Gateway MSC (SMS-GMSC); and wherein said unique reference is a Short Message reference included in a signaling protocol of the telecommunication network, said means for generating said unique reference being optionally configured to generate said SM reference by hashing of the contents of said SM.

20. A telecommunications network comprising a Lawful Interception LI system or a Data Retention system and comprising a plurality of telecommunication nodes according to one or more of claims 10-18.

21. The telecommunications network of claim 20, wherein said communication involving the target user is a Short Message communication, and said telecommunications nodes comprise an originating Mobile Switching Center (MSC), an originating Short Message Service Interworking MSC (SMS-IWMSC), a Short Message Service Center (SC), a terminating Short Message Service Gateway MSC (SMS-GMSC), a terminating MSC, said unique reference being generated by the originating MSC and being passed through said SMS-IWMSC, said SMS-GMSC, said SC and said terminating MSC.

22. A method of providing call related information to a Data Retention (DR) system in a telecommunications network, the method comprising:
providing a node which is in communication with a DR system;
generating, at the node, a record relating to a communication involving a target user;
sending said record to the DR system;
characterized in that said generating the record comprises:
checking whether a unique reference univocally identifying said communication involving the target user is already available to the node and, if not, generating said unique reference;
including said unique reference in said record.

23. The method of claim 22, wherein said communication is a terminating call, an originating call or a Short Message SM.

24. The method of claim 22 or 23, wherein said checking includes checking if said unique reference has been received from a second node of the telecommunications network.

25. The method of one or more of the preceding claims 22-24, wherein said communication involving the target user is a call and said unique reference is a call reference included in a signaling protocol of the telecommunications network; or wherein said unique reference is a Short Message reference included in a signaling protocol of the telecommunication network, said means for generating said unique reference being optionally configured to generate said SM reference by hashing of the contents of said SM.

26. The method of claim 25, wherein said call reference is selected from the group comprising:
a network call reference of an ITU-T ISUP signaling protocol;
a generic digit parameter of an ANSI ISUP signaling protocol;
a global search identity parameter of a TTC ISUP signaling protocol;
a global call reference parameter of a BICC signaling protocol.

27. The method of one or more of claim 24, 25 or 26 further including the step of, before said generating the record, receiving via trunk signaling a message from said second node comprising said unique reference as an information element, wherein said message is preferably received at call setup.

28. The method of claim 22 or 23, wherein said communication involving the target user comprises a plurality of related calls, said checking includes checking if said unique reference is available from at least one of said related calls.

29. The method of one or more of the preceding claims 22-28, wherein said record is sent by the node to the DR system after said call is terminated.
